(19) United States
(12) Patent Application Publication
(10) Pub. No.: US 2006/0219826 A1
(43) Pub. Date: Oct. 5, 2006

(54) SHREDDER FOR REDUCED SHRED SIZE AND METHOD OF CONSTRUCTION THEREOF

(75) Inventor: David K. Yamamoto, Paris (CA)

Correspondence Address: DARYL W SCHNURR;MILLER THOMSON LLP, PO BOX 578, SUITE 700, 22 FREDERICK STREET, KITCHENER, ON, N2G 4A2, CA

(73) Assignee: SHRED-TECH CORPORATION, CAMBRIDGE, ON (CA)

(21) Appl. No.: 11/278,653

(22) Filed: Apr. 4, 2006

Related U.S. Application Data
(60) Provisional application No. 60/667,764, filed on Apr. 4, 2005.

(51) Int. Cl. B02C 18/16

(52) U.S. Cl. 241/30; 241/236

(57) ABSTRACT

This invention relates to a shredder and method of reducing shred size of shredded material by arranging knives on each shaft so that each set of knives has a high number of unique hook positions around a circumference of the set and controlling the locations and numbers of hooks to maintain a low torque load. The knives at the ends of each set have a larger diameter than the remaining knives. Shred sizes can be reduced to approximately half the size of previous shredders with no increase in torque load. A bulkhead wall and spacer assembly is adjustable with recessed portions to block off substantially all of a void that would otherwise exist at the end of each shredder body. A fingerplate assembly is also provided.

Priority is claimed based upon U.S. Provisional Application Serial No. 60/667,764 filed on Apr. 4, 2005,

### BACKGROUND OF THE INVENTION

1. Field of Invention

This invention relates to a method of reducing shred size and a shredder that produces decreased shred size in shredded material and can maximize shredded capacity. This invention further relates to a bulkhead wall and spacer assembly and still further to a fingerplate assembly.

2. Description of the Prior Art

When paper or similar material is shredded, the shredded material is often formed or cut into long strips. While it is very time consuming, circumstances have arisen where a particular business has made allegations that a competitor has sifted through waste materials of the business, has recovered shredded material and has reassembled that shredded material to produce a readable copy of the documents that had previously been shredded. It is common for rotary knife type shredders with knives rotating on parallel shafts, to produce shredded material containing a shred size of approximately ⅝ inches by 4.0 inches for most of the material. Some of the pieces are larger than ⅝ inches by 4.0 inches and, sometimes, large pieces such as whole pieces of paper or folded paper will pass through the shredder in one piece or substantially in one piece. For example, unshredded material can build up at the end of the rotating knives and pass from an inlet to an outlet of the shredder to the outside of the outermost knives. The knives of rotary shredders all have the same diameter and often, the knives at the ends of each set of knives have fewer hooks than the knives in a central portion of each set.

There has been a need for some time to provide a shredder that will shred material into much smaller pieces to make it virtually impossible to reassemble the shredded material. Also, shredded material of reduced size can be compacted to occupy less space than larger sized shredded material. Direct drive shredders and single drive shredders are known.

One of the concerns with reducing the shred size is the likely increase in cost of shredding. With mobile shredders a significant portion of the operating cost arises from fuel costs. Since fuel costs have substantially increased recently, there is concern that reducing shred size will be cost prohibitive as one would expect greater energy consumption.

Fingerplate assemblies are known and are used in shredders to substantially block the space that exists between adjacent knives of the two sets of knives on an outer side of the two shafts. With existing fingerplate assemblies, if a small piece of paper or other material to be shredded is oriented vertically it is possible that that piece of material can pass through the shredder between the fingers of the fingerplate assembly and between or beyond the knives without being shredded or without being sufficiently shredded.

### SUMMARY OF THE INVENTION

It is an object of the present invention to provide a shredder that produces a reduced shred size compared to previous shredders without increasing the power required to operate the shredder It is a further object of the present invention to provide a shredder that produces a high percentage of shredded material that has a length that does not exceed 2.5 inches instead of the more common 4.5 inch length without increasing the torque load required to operate the shredder. It is a further object of the present invention to provide a method of operating a shredder by arranging the location and number of hooks in such a manner that the shredded material has a reduced shred size without a corresponding increase in the torque load of the shredder.

A method of reducing shred size uses a shredder with at least two rotatable shafts and at least two sets of parallel interactive knives having the form of circular plates. One set of knives is located in a spaced relationship on each shaft. The shafts have drive means to rotate the shafts, the knives of each set rotating with each shaft. There is a shredder body surrounding the at least two sets, the knives being spaced apart from one another by substantially a knife width so that alternative knives of one set fit between alternating knives with the other set with the peripheries of the knives of one set overlapping the peripheries of the knives of the other set. Each knife has a periphery with at least two hooks thereon. The method comprises locating the knives on each shaft so that each set has at least thirty unique hook positions around a circumference of the set with at least two hooks of the same set biting material to be shredded at each unique hook position substantially at the same time, controlling locations and numbers of hooks to maintain a low torque load on the shredder while substantially producing shredded material with a small shred size of less than 2.5 inches long, operating the drive means to rotate the shafts, causing the knives of each set to interact with one another, supplying material to be shredded to an inlet of the shredder and collecting shredded material at an outlet of the shredder.

A shredder for producing shredded material comprises at least two sets of parallel interactive knives in the form of circular plates and at least two shafts, one set of knives being located on each shaft, the shaft having drive means to rotate the shafts. The knives of each set rotate with each shaft with a shredder body surrounding the at least two sets. The knives are spaced apart from one another by substantially a knife width so that alternating knives of one set fit between alternating knives of the other set with peripheries of the knives of one set overlapping peripheries of the knives of the other set. Each knife has a periphery with hooks thereon. The shredder has a bulkhead wall located between an end of each set of knives and shredder body. The bulkhead wall has a first recessed portion that is sized and shaped to receive an outermost knife of each set, there being two bulkhead walls.

A shredder for producing shredded material comprises at least two sets of parallel interactive knives in the form of circular plates and at least two shafts, one set of knives being located on each shaft, the shaft having drive means to rotate the shafts. The knives of each set rotate with each shaft with a shredder body surrounding the at least two sets. The knives are spaced apart from one another by substantially a knife width so that alternating knives of one set fit between alternating knives of the other set with peripheries of the knives of one set overlapping peripheries of the knives of the other set. Each knife has a periphery with hooks thereon. The shredder has a fingerplate assembly with fingers extending inward between the knives. The fingers are mounted in a spaced relationship on a base with a barrier extending inward from the base longitudinally on the fingerplate assembly. The barrier blocks spaces between the fingers in an area near the base to prevent material to be shredded that is oriented in a vertical plane from passing through the shredder near the base without being shredded.

A shredder for producing a reduced shred size of shredded material comprises at least two sets of parallel interactive knives in the form of circular plates and at least two shafts. One set of knives is located on each shaft. The knives of each set rotate with each shaft, with a shredder body surrounding the at least two sets. The knives are spaced apart from one another by substantially a knife width so that alternating knives of one set fit between alternating knives of the other set with the peripheries of the knives of one set overlapping the peripheries of the knives of the other set. Each knife has a periphery with at least two hooks thereon. The knives are oriented on each shaft so that each set of knives has at least thirty unique hook positions around a circumference of the set with at least two hooks of the same set biting material to be shredded at each unique hook position at substantially the same time. The shredder has drive means to rotate the at least two shafts. The hooks are located to cause the knives of each set to interact with one another to shred material provided to the shredder and to produce shredded material from the shredder of small shred size at a low torque load.

The shaft and knives of the shredder can be formed from one piece of material so that the knives and shaft of each set are integral with one another.

As a further alternative, knives and spacers can be integral with one another for placement onto a shaft for each set.

### BRIEF DESCRIPTION OF THE DRAWINGS

FIG. 1 is a front view of a circular knife plate having two hooks thereon;

FIG. 2 is an edge view of the knife of FIG. 1;

FIG. 3 is a front view of a circular knife plate having four hooks thereon;

FIG. 4 is an edge view of the knife of FIG. 3;

FIG. 5 is a graph of a location of the hooks of each knife on each shaft, there being thirty six knives on each shaft and six offsets;

FIG. 6 is a perspective view of a bulkhead wall;

FIG. 7 is a top view of a spacer assembly;

FIG. 8 is an edge view of a bulkhead wall and spacer assembly;

FIG. 9 is a top view of a prior art shredder;

FIG. 10 is a perspective view of the prior art shredder of FIG. 9;

FIG. 11 is a perspective view of a shredder having an independent direct drive system;

FIG. 12 is an end view of two sets of knives intermeshing with one another;

FIG. 13 is a side view of one set of knives along a shaft;

FIG. 14 is a top view of two sets of knives intermeshing with one another;

FIG. 15 is a perspective view of two sets of knives intermeshing with one another;

FIG. 16 is a perspective view of a fingerplate assembly;

FIG. 17 is a front view of the fingerplate assembly; and

FIG. 18 is an end view of the fingerplate assembly.

### DETAILED DESCRIPTION OF A PREFERRED EMBODIMENT

A unique hook position of a set is any point around a circumference of said set where a hook is located provided that where two or more hooks are located at substantially the same point on said circumference to engage material to be shredded at substantially the same time, but longitudinally apart from one another on different knives, the two or more hooks are considered to be one unique position. For example, if an angular orientation from two or more hooks on different knives of the same set to the longitudinal axis of the shaft of that set is substantially the same, then those two or more hooks have the same unique hook position. Furthermore, knife hooks with the same unique hook position that engage material to be shredded at substantially the same time are considered active hooks when the material is engaged. When the material is said to be engaged by a knife hook, the hook is actively biting the material. All active hook is a hook that is actively biting the material to be shredded.

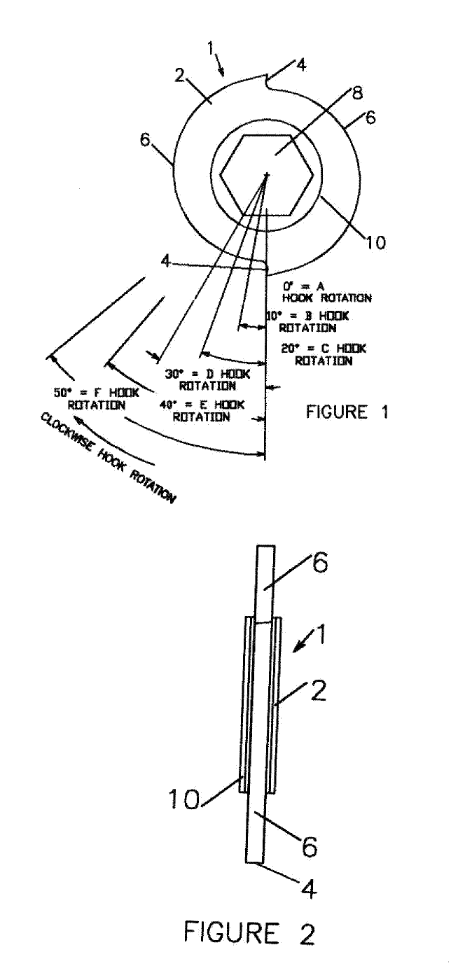

FIG. 1 is a front view of a knife 1, being a circular plate 2 having two hooks 4 equally spaced apart from one another on a periphery 6 thereof The plate 2 has a central hexagonally shaped opening 8 therein to conform with a cross-sectional shape of a shaft (not shown in FIG. 1). The plate 2 has a spacer 10 integrally formed thereon. Alternatively, a knife can have spacers that fit separately onto the shafts to maintain adjacent knives in a spaced relationship relative to one another. In a further alternative, knives and spacers can be grouped and machined as a single unit or multiple pieces (ie. ganged segments). By radial lines in a lower left part of the plate 2, there are shown locations for 10 degree offsets up to a total of 50°. In FIG. 2, there is shown an edge view of the knife 1. The same reference numerals are used in FIG. 2 as those used in FIG. 1 to describe the identical components.

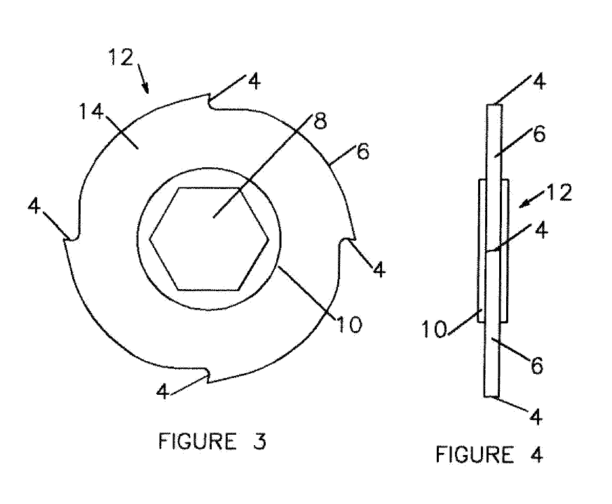

In FIGS. 3 and 4, there is shown a front view and edge view respectively of a knife 12 that is a circular plate 14 having four hooks 4 on a periphery 6 thereof. The same reference numerals are used in FIGS. 3 and 4 to describe those components that are identical to the components described in FIGS. 1 and 2. The knife 12 has a larger diameter than the knife 1. Preferably, knives similar to the knife 12 are located at ends of a shaft (not shown in FIGS. 3 and 4) and knives similar to the knife 1 are located in a central portion of the shaft of a shredder (not shown in FIGS. 3 and 4).

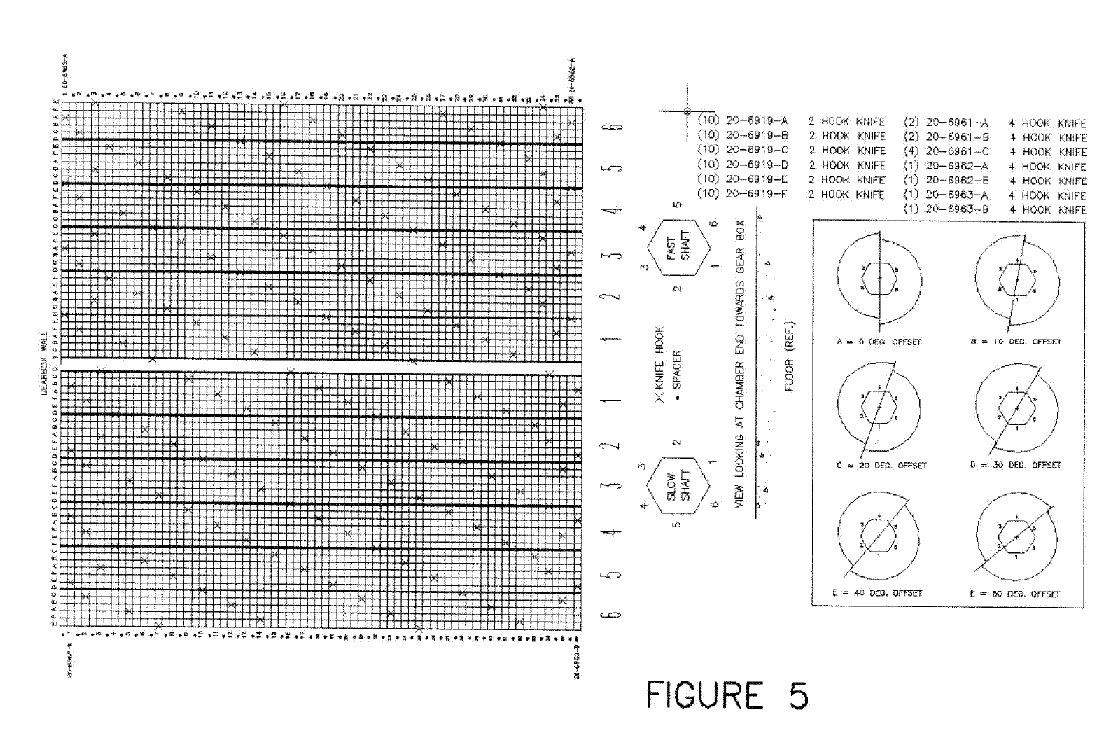

FIG. 5 is a graph showing a sample configuration of two sets of knives with one set being located on a first hexagonally shaped shaft and a second set being located on a second hexagonally shaped shaft. As can be seen from the graph there are 36 knives in each set and each of the adjacent knives are separated from one another by one knife width by a spacer or spacers. The spacers are either integral with the knife plates or are separately mounted on the shafts in an alternating relationship with the knife plates. In the right hand side of FIG. 5, there are shown six schematic drawings of knives (A to F) with each one having a different number of degrees of offset relative to the 0° degree offset designated as “A”. It will be noticed that these six knives have a different orientation of the two hooks relative to the central opening for each offset. The “x's” on the graph show the location of the knife hook for each of the six flats of the hexagonal shaped shafts described in the central portion of the drawing. The flats are the flat portions of the hexagonal shape. At a given time, there are always at least two active hooks of one set that have the same orientation relative to the shaft and therefore engage the into material to be shredded as the shafts are rotated. In some instances, there are three active hooks having the same orientation on one set. Shredders are usually designed so that one shaft turns at a faster speed than the other shaft and therefore it is possible that hooks of one set will sometimes be active simultaneously with hooks of the other set. Each set of knives shown in FIG. 5 has thirty six unique hook locations and six offsets. An offset of a particular set of knives is the circumferential distance that adjacent hooks are apart from one another. In other words, when two adjacent hooks of two knives are viewed from a direction parallel to the shaft, the offset is the circumferential distance that the hooks are apart from one another. In the graph shown, the offsets are ten degrees apart from one another and the six knife schematics shown on the right hand side can be used to create thirty six unique hook positions around the circumference of the shaft simply by placing the plates onto the shaft at different orientations. The configuration shown in FIG. 5 is an example only and the invention is not limited thereto.

In FIG. 5, each flat (being any one of the six flat portions of the hexagonally shaped flat) is divided into six equal sections. Commencing at a centre of the graph, there are thirty-six sections for each set from an apex of the first flat being the inner line of each set on the graph) to the last section of the sixth flat (being the outer line of each set). The inner line of the set shown at the top of the graph has two knife hooks (x's) aligned therewith and the outer line of the same set has three knife hooks (x's) aligned therewith.

The capacity of a shredder can be increased by increasing the number of offsets, to maximize the total number of hooks within the cutting chamber without changing the number of active hooks at any given time. Compared to the configuration of FIG. 5, which has 10° offsets, the offsets will be less than 10° apart from one another. This will increase the capacity of the shredder without increasing the torque load as the number of active hooks does not change. In another embodiment, a shredder can be designed to have several hooks that have a unique position so that for part or all of the time that the shredder operates, only one hook of each set bites material to be shredded at substantially the same time.

It has been determined that increasing the number of offsets results in much smaller shred size for shredded material with virtually the same level of power input. It has also been discovered that thinner knives can be used as there are more offsets and more unique positions for hooks. With thinner knives, there are more knives located along a shaft of a given length. Increasing the total number of hooks does not require an increase in power input and results in improved torque load control Decreased hook size will result in a lower knife force requirement permitting more active hooks simultaneously cutting and result in smaller shred size with no increase in power requirement.

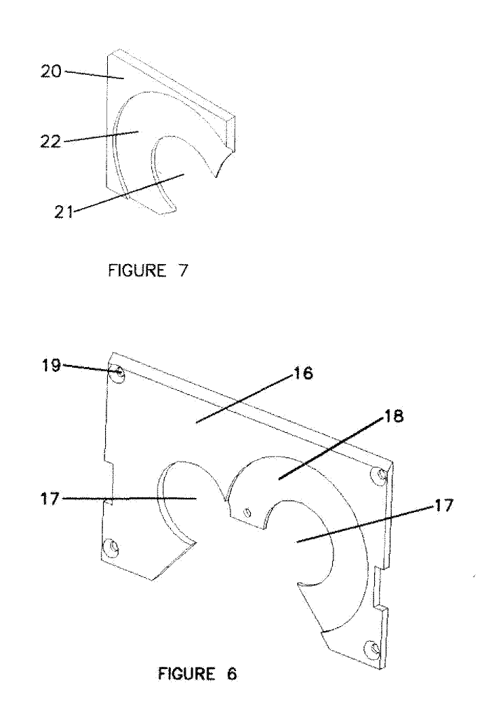

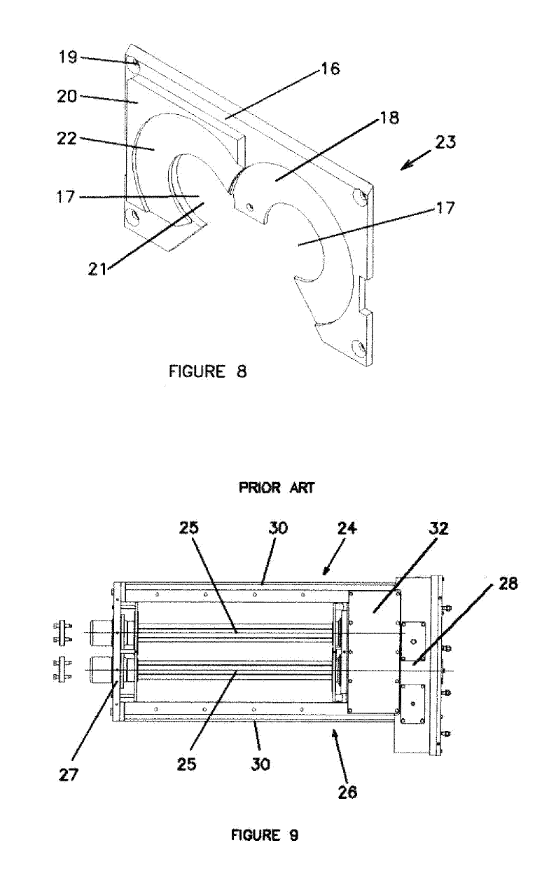

In FIG. 6, there is shown a perspective view of a bulkhead wall 16 having openings 17 therein for the shafts (not shown in FIG. 6) of a shredder (not shown in FIG. 6). The bulkhead wall 16 has a recessed arc-shaped portion 18 corresponding to a knife (not shown in FIG. 6). There are holes 19 in each corner of the bulkhead wall 16 to allow the bulkhead walls to be affixed to a shredder body (not shown in FIG. 6). In FIG. 7, there is shown a perspective view of a spacer 20 having a circular opening 21 to accommodate the shaft (not shown in FIG. 7) of a shredder (not shown in FIG. 7). A recessed arc-shaped portion 22 extends adjacent to the opening 21 and corresponds to a knife (not shown in FIG. 7). In FIG. 8, there is shown a perspective view of a bulkhead wall and spacer assembly 23. The spacer 16 is affixed to the left hand side of the bulkhead wall 16 with the opening 21 aligned with the left hand opening 17. The same reference numerals are used in FIG. 8 as those used in FIGS. 6 and 7 to describe those components that are identical. The bulkhead wall and spacer assembly 23 is inserted at each end of a shredder (not shown in FIGS. 6, 7 and 8) so that the knives at the end of the shredder (not shown in FIGS. 6, 7 and 8) are immediately adjacent to the recessed arc-shaped portions 18, 22. The recessed-shaped portion 22 is located further inward than the recessed-shaped portion 18 as the end knife of one set (not shown in FIGS. 6, 7 and 8) is located closer to an end wall of the shredder (not shown in FIGS. 6, 7 and 8) than the end knife of the other set (not shown in FIGS. 6, 7 and 8). The bulkhead wall and spacer assembly is designed to fit within what would otherwise be a void between a shredder body (not shown in FIGS. 6 to 8) and the outer two knives of each set immediately adjacent to the shredder body at either end of the shredder. The bulkhead wall and spacer assembly is sized and shaped to fill the void so that material to be shredded is prevented from entering the void. When material to be shredded is allowed to enter the void, it can proceed through the shredder without being shredded. The bulkhead wall and spacer assembly is recessed to block the void and partially overlap the end knives at both shafts so that any material to be shredded can only pass through the shredder by passing through the knives. Paper or other material to be shredded that falls on the wall and spacer assembly is deflected by a bevelled upper edge of the bulkhead wall and spacer assembly toward a center of the shredder. The paper or other material to be shredded is cut more effectively in a center of the shredder. The bulkhead wall and spacer assembly is adjustable so that it can be moved closer to the outermost knives or further from the outermost knives as desired.

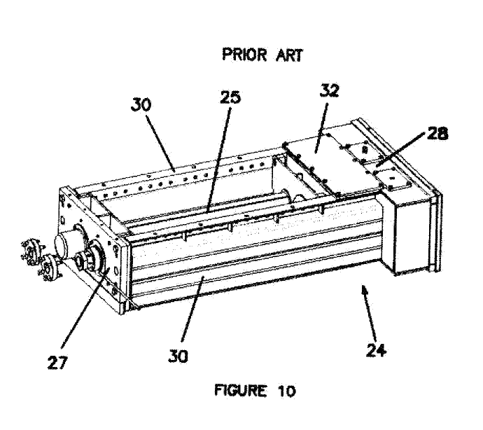

In FIGS. 9 and 10, there is shown a top view and a perspective view respectively of a prior art shredder 24 that has a single drive means (not shown) at one end to drive both shafts 25. The shredder 24 has a shredder body 26 with ends 27, 28 and sides 30. An internal gear arrangement inside gearbox 32 is used to connect the two shafts 25. The shredder 24 is much more complex than a direct drive shredder and has many more components. The knives have been deleted to expose the shafts. The shredder is not described in great detail as it is conventional. Also, since both shafts are driven by the same drive means, the shafts are usually made to rotate at a differential speed and if the direction of rotation of one of the shafts is reversed, the direction of rotation of the other shaft is also reversed. In other words, one shaft might be setup through the gear arrangement to rotate twenty percent faster than the other shaft. Preferably, the drive means for the shredder is a hydraulic motor or motors (not shown) but electric motors are also suitable.

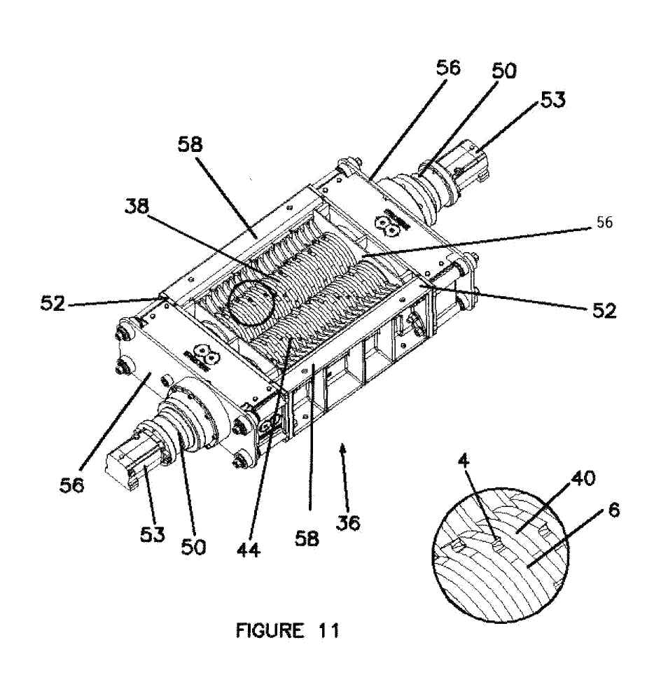

In FIG. 11, there is shown a perspective view of a shredder 36 having a first set 38 of knives 40 extending along a first longitudinal axis (not shown). A second set 44 of knives 40 extends along a second longitudinal axis (not shown). The first set 38 of knives 40 is rotatably mounted on a first shaft 48 and the second set 44 of knives 40 is rotatably mounted on a second shaft 50, the shafts 48, 50 being rotatable about the first and second longitudinal axes respectively. The knives 40 are in a spaced relationship along the two axes and are generally circular plates with cutting means 52 on a periphery 6 of each plate. The first and second longitudinal axes are located to enable the knives 40 of the first set 38 to partially fit between the knives 40 of the second set 44. The shredder 36 has two ends 56 and two sides 58 that together form a shredder body. The two ends 56 are preferably made of aluminum, to reduce the weight of the shredder, or other material and rotatably support each of the sets 38, 44. It can be seen that the shafts 48, 50 extend through each of the ends 56 and are each mounted in bearings at both ends (not shown). The bearings (not shown) are located at a drive end of each of the shafts 48, 50 and there are bearings (not shown) located at an opposite end. The first and second sets 38, 44 are each driven by independent, direct drive means 53, The drive means 53 is connected to the drive end of each of the shafts 48, 50 and are conventional. The two sides 58 of the shredder body are made from aluminum to reduce the weight of the shredder without sacrificing the performance. The aluminum sides preferably have a lattice shape and, still more preferably, have a ladder shape. For the purposes of the present invention, the shredder body can be made of any suitable material. The drives 53 of the shredder 36 are preferably hydraulic motors connected to a planetary reducer, there being a separate drive for each shaft. There is a prior art fingerplate assembly 68 along each side of the shredder 36. The same reference numerals are used in FIG. 11 as those used in FIGS. 1 to 10 for those components that are identical.

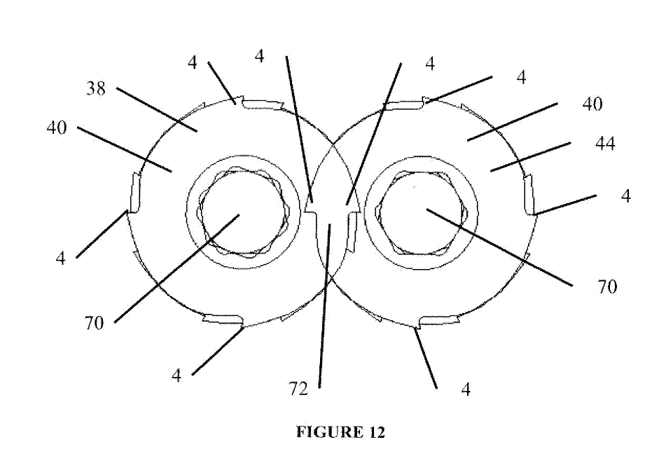

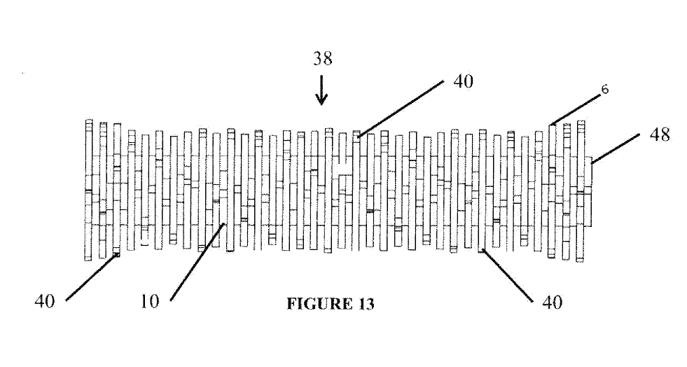

In FIG. 12, there is shown a schematic end view of two sets 38, 44 of knives 40 intermeshing with one another. The knives are shown as having a hexagonal opening 70. The opening 70 will have a shape corresponding to the shape of the shaft upon which the knives are mounted. The shaft is not shown in FIG. 12. Preferably, the shaft has a hexagonal cross-section, but other cross-sectional shapes or a key-way or a channel or splines or any other suitable means can be used to prevent the knives from rotating relative to the shaft on which they are located. Each of the two end knives 40 shown has four hooks 4 thereon, but more than four hooks are visible as the hooks from knives behind the two knives 40 can also be seen. There is an overlap portion 72 of the knives that is shown to expose how far the knives overlap. The overlap portion 72 would be hidden by the first knife 40 of the set 38.

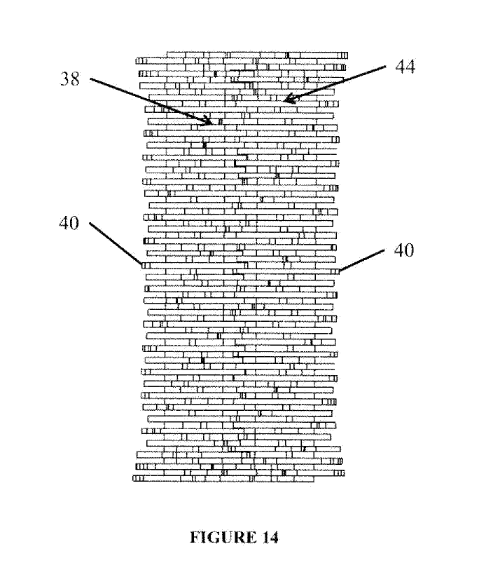

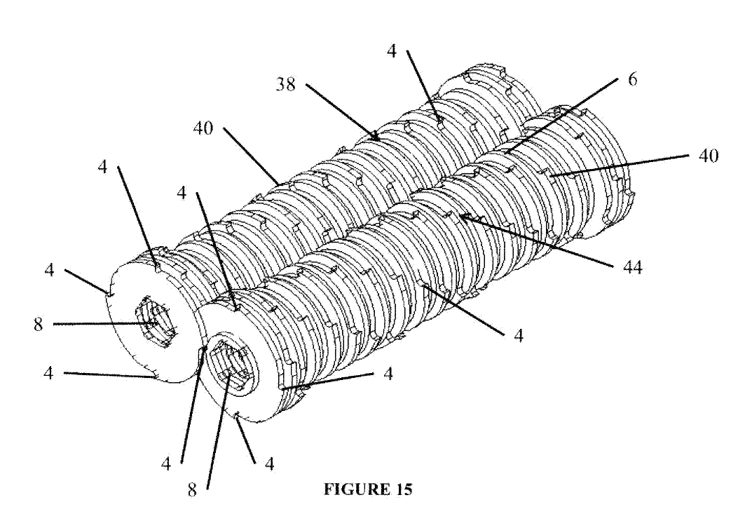

In FIG. 13, there is shown a side view of one set 38 of knives 40 along a shaft 48. It can be seen that the knives are spaced apart from one another by substantially one knife width and that the knives at the ends have a larger diameter than the knives in the central portion. In FIG. 14, there is shown a schematic top view of two sets 38, 44 of knives 40 intermeshing with one another. The two shafts are not shown in FIG. 14. In FIG. 15, there is shown a perspective view of the two sets 38, 44 of knives 40. It can be seen that the knives have a periphery 6 with cutting means thereon. The cutting means are hooks 4 and the three knives 40 on the left and right end of the sets 38, 44 have four hooks each. The remaining knives of each set have two hooks each. the knives are oriented so that the hooks are offset from one another, for example, as previously described in FIG. 5. The shafts are not shown and the knives 40 of each set have a central opening 8.

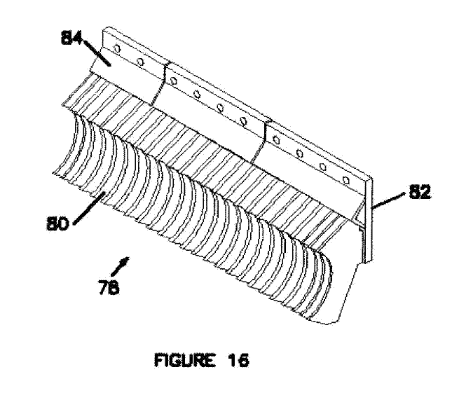

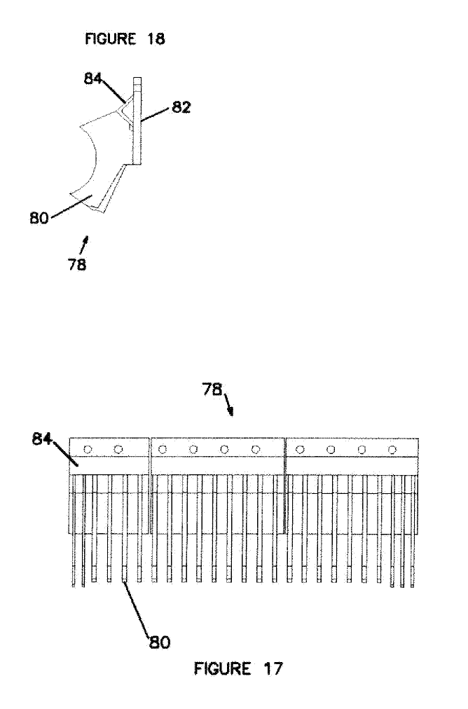

In FIGS. 16, 17, and 18, there is shown a perspective view, front view, and end view respectively of a fingerplate assembly 78. There is one fingerplate assembly on each side of the shredder (not shown in FIGS. 16 to 18). The purpose of the fingerplate assemblies is to substantially block off the space between the knives on the outer side of the two sets (not shown in FIGS. 16 to 18). The fingerplate assembly 78 has a plurality of spaced fingers 80 that fit between the knives (not shown in FIGS. 16 to 18) extending downward and inward from a base 82. A barrier 84 is affixed to the base 82 and extends inward above a portion of the fingers 80. When shredding material such as paper, relatively small pieces of paper, for example, checks, can pass through the shredder in a vertical orientation between the fingers and beyond the outer edge of the knives or between the knives. The barrier 84 blocks a sufficient portion of the spaces between the fingers and is angled downward and inward so that any paper falling onto the barrier 84 is directed toward a center of the shredder. The barrier also prevents relatively small pieces of paper from being oriented vertically by said fingers and from passing through said shredder without being shredded.

When shredding material such as paper with the present invention, a high proportion of the paper is not cut into long strips (approximately four inches) but is shredded into relatively small pieces having a short length with a substantial quantity less than approximately 2.5 inches. The width of the pieces is approximately equal to the width of a single knife. Since narrower knives can be used, the width of shred pieces also decreases. The knives on a shaft of a shredder can be oriented to control the torque load and to reduce the shred size of the shredded material over previous mobile shredders having two or more sets of intermeshing knives mounted on separate rotating shafts. The locations and number of hooks is chosen to control the torque load and the shred size. Preferably, the knives are circular plates having at least two hooks spaced equally around the periphery of the knife. A circular plate can have three hooks or four hooks. Two, three and four hooks are preferred, but a knife can have more than four hooks. When larger diameter knives are used, the optimum number of hooks per knife will increase. The knives of each set are oriented so that at least two hooks of the same set have an identical location relative to the shaft at each unique hook location and those at least two hooks contact material to be shredded simultaneously as the knives of the set rotate. Those at least two hooks can be described as being active hooks as they are contacting material to be shredded at substantially the same time. Preferably, the at least two active hooks are not located on adjacent knives and are preferably located on knives that are some distance apart from one another.

Preferably, the knives are oriented so that there are at least thirty unique hook positions relative to the shaft. Still more preferably, there are at least thirty six unique hook positions. In other words, the knives are oriented so that as soon as at least two active hooks substantially complete their shredding action, there are at least two further hooks that are becoming active hooks. Preferably, the knives are oriented so tat the hooks of the same set on all of the knives taken together are distributed approximately equally around a circumference of an imaginary cylinder along the periphery of all of the knives of the same set. For example, the equal spacing can be in a range from substantially eight degrees to substantially twelve degrees around the imaginary circumference of each set. The spacing will vary with the diameter of the knives. Larger diameter knives can have more hooks at smaller angles than smaller diameter knives. In other words, if there are thirty six unique hook locations and the hooks are substantially equally spaced relative to one another, then the successive active hooks will be ten degrees apart from one another. Similarly, if there are thirty unique hook locations, the successive active hooks will be twelve degrees apart from one another. If there are forty unique hook positions, the successive active hooks will be nine degrees apart from one another and if there are forty five unique hook positions, the successive active hooks will be eight degrees apart from one another. Variations may be made within this range and sometimes it may be preferable to go outside this range. If the successive active hooks are too close together the cutting action of one set of active hooks might overlap with the cutting action of a subsequent set of active hooks. An overlap in cutting action is usually undesirable as it results in higher torque being required. Larger shredders will have a greater number of total hooks in the cutting chamber than smaller shredders.

Shorter hook height allows smaller offsets since shredding action is completed in less circumferential distance and less knife force is required to perform the cut. This permits installation of more hooks in a set and more active hooks cutting simultaneously Larger diameter knives in larger shredders permit more offsets since the circumferential distance is greater, particularly when compared to same size hooks of a smaller shredder.

This novel arrangement of hooks results in a lower maximum tip force requirement for each hook since narrower knives can be used. Preferably, the knives near the outer ends of each set have a larger diameter than the remaining knives. Preferably, the knives at the outer end of each set have four hooks per knife or at least an increased number of hooks over the remaining knives in the center portion of the set. It is important when shredding material, particularly paper, that the shredded material not be shredded to such an extent that substantial amounts of dust or powder are created, In other words, when shredding paper, it is not desirable to shred the paper to such a degree that the paper is converted essentially to dust. The dust cannot be recycled and creates a storage, material handling and transport problems as well as safety concerns as paper dust is explosive. With the present invention, the shred size of the shredded material is reduced over that resulting from prior art shredders, but the shredded material is numerous pieces of paper and the like and very little dust is created.

The variables that can be used to control torque load on the shredder begin with the number of unique hook locations and the number of hooks cutting simultaneously. By having a large number of unique hook locations, as the knives of each set rotate, as soon as the active hooks are finished cutting one area of the shredded material, another group of active hooks moves into position to cut another area of the shredded material. This continues around the entire 360° circumference of the circular knife plates. Ideally, the hook spacing is such that sequential active hooks around the imaginary circumference of each set substantially complete their shredding action independently or in transition. Increased unique hook locations allow the use of narrower knives while maintaining the same number of actively cutting hooks and decreasing the force requirement per hook. For example, for thirty-six offsets with three active hooks per offset, there are 108 total hook. Since narrower knives are used, the total number of hooks for a given size shredder increase. The larger diameter knives at the ends of the cutting chamber significantly assist reorientation of paper. The diameter of knives can be progressively reduced from the ends towards a central area of each set of knives or an abrupt change in diameter can be made between the two or three knives at each end of a set and the remaining knives. Higher elevation at the ends of the chamber promotes gravity migration of material away from the ends of the cutting chamber towards the central area where more efficient cutting action occurs. Higher knife tip speed also promotes better migration. An increased number of hooks on the end knives also assists in material reorientation and reduces shred length. Auger orientation of the knife hooks on the large diameter knives also promotes movement of material away from the ends. By reducing the width of knives at the outer ends of the cutting chamber, the width of material that could fit sideways between the knives is also decreased. A smaller hook height on the knives at the end of the cutting chamber creates a smaller shred size for material that might otherwise lay flat against the end wall. Larger diameter knives decrease the space between the knife tip and opposing spacer promoting decreased shred size. Consistent alternating large offset rotation in knife hook locations produces a consistently short shred size. A large number of unique hook locations coupled with the pattern of hooks produces consistent biting action on flake type materials like paper.

Both the bulkhead wall and spacer assembly and the fingerplate assembly can be used with conventional shredders or shredders that do not have the size reduction features of the present invention to improve the performance of those shredders. The bulkhead wall and spacer assembly can be used in conjunction with the fingerplate assembly or it can be used independently to improve the performance of any type of shredder, including conventional shredders.

Numerous variations will be readily apparent to those skilled in the art within the scope of the claims.

I claim:

1. A method of reducing shred size of shredded material using a shredder with at least two rotatable shafts and at least two sets of parallel interactive knives having the form of circular plates, one set of knives being located in a spaced relationship on each shaft, said shafts having drive means to rotate said shafts, said knives of each set rotating with each shaft, with a shredder body surrounding said at least two sets, said knives being spaced apart from one another by substantially a knife width so that alternating knives of one set fit between alternating knives of the other set with the peripheries of said knives of one set overlapping the peripheries of said knives of the other set, each knife having a periphery with at least two hooks thereon, said method comprising locating said knives on each shaft so that each set has at least thirty unique hook positions around a circumference of said set with at least two hooks of the same set biting material to be shredded at each unique hook position substantially at the same time, controlling locations and numbers of hooks to maintain a low torque load on said shredder relative to a maximum torque load for the shredder while substantially producing shredded material with a small shred size of less than 2.5 inches long, operating said drive means to rotate said shaft, causing said knives of each set to interact with one another, supplying material to be shredded to an inlet of said shredder and collecting shredded material at an outlet of said shredder.

2. A method as claimed in claim 1 including the step of arranging said knives on each shaft so that each set has at least thirty-six unique hook positions around said circumference.

3. A method as claimed in claim 1 including the steps of choosing a shaft having a hexagonal cross-section, forming six different circular plate knives that are offset from a central hexagonal opening by progressions of ten degrees, forming additional copies of said six plate knives and assembling said one set and said other set with thirty-six unique hook positions on each set by installing copies of said six circular plate knives on each shaft in different orientations.

4. A method as claimed in claim 1 including the step of using substantially more than thirty six knives on each shaft by using knives having a narrow width of less than substantially 0.6 inches.

5. A method as claimed in claim 4 including the step of using narrower knives having a width of less than substantially 0.5 inches.

6. A method as claimed in claim 5 including the step of using knives having a narrower width of less than substantially 0.4 inches.

7. A method as claimed in claim 1 including the step of using wider knives in a central area of each shaft and narrower knives at either end of each shaft.

8. A method as claimed in claim 1 including the step of choosing knives at an end of each shaft that have a larger diameter than a remainder of said knives.

9. A method as claimed in claim 1 including the step of inserting a block on each end of each shaft between an outermost knife at each end and a shredder body to fill a void that would otherwise occur, thereby preventing the transfer of non-shredded material through said void.

10. A method as claimed in claim 1 including the step of using more than two hooks per knife and spacing said hooks substantially equally around a periphery of each knife.

11. A method as claimed in claim 8 including the step of controlling the torque load by increasing the number of hook positions per set.

12. A method as claimed in claim 1 including the step of increasing a number of unique hook positions resulting in a greater number of hooks within a cutting chamber to reduce a shred size without increasing power input.

13. A method as claimed in claim 1 including the step of increasing the number of hooks per knife on those knives located on each end of each shaft.

14. A method as claimed in claim 1 including the step of reducing the height of each hook on end knives to create a smaller shred size for material at said ends.

15. A method as claimed in claim 1 including the steps of substantially equally spacing said offsets around said circumference.

16. A method as claimed in claim 1 wherein said at least two hooks that engage material simultaneously at each unique hook position are active hooks, said method including the steps of locating said active hooks so that there are never two active hooks on adjacent knives at any unique hook position.

17. A method as claimed in claim 1 including the step of installing a recessed bulkhead on each end of said shaft between an outermost knife of one of said sets and a shredder body to fill a void that would otherwise occur, thereby preventing the transfer of non-shredded material through said void, said bulkhead having a first recessed portion that is sized and shaped to receive part of said outermost knife.

18. A method as claimed in claim 17 wherein said bulkhead has a second recessed portion, said second recessed portion being sized and shaped to receive part of an outermost recessed knife of another of said sets, there being two recessed portions, one for each outermost knife of each set at each end of each set, said bulkhead wall being adjustable relative to said knives, said method including the steps of adjusting said bulkhead walls to be close to but not in contact with said knives.

19. A method as claimed in claim 1 including the steps of choosing a hook size for said knives.

20. A method as claimed in claim 1 wherein there is a fingerplate assembly along each side of said shredder body, said fingerplate assembly having a plurality of spaced fingers mounted on a base, said method comprising blocking off said fingers near said base with a barrier.

21. A method as claimed in claim 8 wherein a plurality of knives at an end of each set have said larger diameter with hooks oriented to move paper away from end walls of a cutting chamber.

22. A method of reducing shred size of shredded material using a shredder with at least two rotatable shafts and at least two sets of parallel interactive knives having the form of circular plates, one set of knives being located in a spaced relationship on each shaft, said shafts having drive means to rotate said shafts, said knives of each set rotating with each shaft, with a shredder body surrounding said at least two sets, said knives being spaced apart from one another by substantially a knife width so that alternating knives of one set fit between alternating knives of the other set with the peripheries of said knives of one set overlapping the peripheries of said knives of the other set, each knife having a periphery with at least two hooks thereon, said method comprising locating said knives on each shaft so that each set has at least thirty different hook positions around a circumference with a plurality of the total hooks having a hook position in which only one hook of the same set bites material to be shredded at substantially the same time, controlling locations and numbers of hooks to maintain a torque load on said shredder while producing shredded material with a small shred size, operating said drive means to rotate said shafts, causing said knives of each set to interact with one another, supplying material to be shredded to an inlet of said shredder and collecting shredded material at an outlet of said shredder.

23. A method as claimed in claim 22 including the steps of locating said knives on each shaft so that a majority of the total hooks have a hook position in which only one hook of the same set bites material to be shredded at substantially the same time.

24. A method as claimed in claim 23 including the step of locating said knives on each shaft so that substantially all of said hooks have a hook position in which only one hook of the same set bites material to be shredded at substantially the same time.

25. A method as claimed in claim 1 including the step of integrally forming said knives by machining said knives from a single piece or ganged segments.

26. A method as claimed in claim 1 including the step of forming said knives and shafts by machining said knives and shaft from a single piece.

27. A shredder for producing a reduced shred size of shredded material, said shredder comprising at least two sets of parallel interactive knives in the form of circular plates and at least two shafts, one set of knives being located on each shaft, said shafts having drive means to rotate said shafts, said knives of each set rotating with each shaft, with a shredder body surrounding said at least two sets, said knives being spaced apart from one another by substantially a knife width so that alternating knives of one set fit between alternating knives of the other set with the peripheries of said knives of one set overlapping the peripheries of said knives of the other set, each knife having a periphery with at least two hooks thereon, said knives being located on each shaft so that each set of knives has at least thirty unique hook positions around a circumference of said set with at least two hooks of the same set actively biting material to be shredded at each unique hook position at substantially the same time, said shredder having drive means to rotate said at least two shafts, said hooks being located to cause said knives of each set to interact with one another to shred material provided to said shredder and to produce shredded material from said shredder of small shred size at a low torque load.

28. A shredder as claimed in claim 27 wherein said shaft has a hexagonal cross-section and each of said knives has a centrally located opening corresponding to said cross-section of said shaft, said opening being oriented relative to said hooks in said knives to create said unique hook positions.

29. A shredder as claimed in claim 27 wherein the at least two hooks that simultaneously bite material to be shredded at each unique hook position are not located on adjacent knives.

30. A shredder as claimed in claim 27 wherein there is a bulkhead wall located between an end of each set of knives and shredder body, said bulkhead wall having a first recessed portion that is sized and shaped to receive an outermost knife of each set, there being two bulkhead walls.

31. A shredder as claimed in claim 30 wherein there is a second recessed portion in said bulkhead wall so that each outermost knife of each set is located at least partially within one of said recessed portions.

32. A shredder as claimed in claim 30 wherein said bulkhead wall is adjustable relative to said outermost knives of each set so that said recessed portions are very close to said outermost knives but not in contact therewith.

33. A shredder as claimed in claim 27 wherein there is a fingerplate assembly along each side of said shredder body, said fingerplate assembly having fingers mounted on a base in a spaced relationship relative to one another, said fingers extending inward between adjacent knives, said fingerplate assembly having a barrier extending inward from said base to block spaces located between said fingers in an area near said base to prevent material to be shredded from becoming oriented in a vertical plane by said fingers and from passing through said shredder near said base without being shredded.

34. A shredder as claimed in claim 27 wherein said small shred size is the size of less than 2.5 inches long.

35. A shredder for producing shredded material, said shredder comprising at least two sets of parallel interactive knives in the form of circular plates and at least two shafts, one set of knives being located on each shaft, said shaft having drive means to rotate said shafts, said knives of each set rotating with each shaft, with a shredder body surrounding said at least two sets, said knives being spaced apart from one another by substantially a knife width so that alternating knives of one set fit between alternating knives of the other set with peripheries of said knives of one set overlapping peripheries of said knives of said other set, each knife having a periphery with hooks thereon, said shredder having a bulkhead wall located between an end of each set of knives and shredder body, said bulkhead wall having a first recessed portion that is sized and shaped to receive an outermost knife of each set, there being two bulkhead walls.

36. A shredder as claimed in claim 35 wherein there is a second recessed portion in said bulkhead wall so that each outermost knife of each set is located at least partially within one of said recessed portions.

37. A shredder as claimed in claim 35 wherein said bulkhead wall is adjustable relative to said outermost knives of each set so that said recessed portions are very close to said outermost knives but not in contact therewith.

38. A shredder for producing shredded material, said shredder comprising at least two sets of parallel interactive knives in the form of circular plates and at least two shafts, one set of knives being located on each shaft, said shaft having drive means to rotate said shafts, said knives of each set rotating with each shaft, with a shredder body surrounding said at least two sets, said knives being spaced apart from one another by substantially a knife width so that alternating knives of one set fit between alternating knives of the other set with peripheries of said knives of one set overlapping peripheries of said knives of said other set, each knife having a periphery with hooks thereon, said shredder having a fingerplate assembly with fingers extending inward between said knives, said fingers being mounted in a spaced relationship on a base, with a barrier extending inward from said base longitudinally on said fingerplate assembly, said barrier blocking spaces between said fingers in an area near said base to prevent material to be shredded that is oriented in a vertical plane from passing through said shredder near said base without being shredded.

39. A shredder as claimed in claim 27 wherein said shaft has knives that are integral therewith.
